(19) United States
(12) Patent Application Publication
(10) Pub. No.: US 2026/0115944 A1
(43) Pub. Date: Apr. 30, 2026

(54) SCISSORS FOR CUTTING NEXT TO A SEAM

(71) Applicant: Mikhail Andreevich Novikov, Ekaterinburg (RU)

(72) Inventor: Mikhail Andreevich Novikov, Ekaterinburg (RU)

(21) Appl. No.: 18/261,552

(22) PCT Filed: Aug. 11, 2020
(86) PCT No.: PCT/RU2020/000423

§ 371 Date: Jul. 14, 2023

(51) Int. Cl. B26B 13/06

(52) U.S. Cl. CPC B26B 13/06

(57) ABSTRACT

The invention relates to scissors for cutting off inseam or sewn on labels (brand labels, care labels, manufacturer labels, etc.) from clothing, but can also be used in other fields. The scissors include first and second lever elements, each having a working portion on one end and a handle on the other end, the elements being interconnected such as to be movable in relation to one another; the working portion of the second lever element has a cutting edge, and the working portion of the first lever element has at least one longitudinal slit for receiving a material to be cut off, the slit giving rise to an inner blade member extending inwardly from the slit and an outer blade member extending outwardly from the slit, wherein the outer blade member extending outwardly from the slit has an edge that is positioned to be capable of contacting with the cutting edge of the working portion of the second lever element along the cutting line.

### TECHNICAL FIELD

The invention relates to a non-standard specialized hand tool, namely, scissors, which are designed to cut sewn or stitched labels (tags, labels, articles, etc.) from clothes, but can also be used in other areas.

### PRIOR ART

Labels are essential clothing items. They contain information about its country of origin, manufacturer and/or supplier identifier, size, material composition data, etc. The label may include care instructions for the product. Being inside clothes, labels made of silk, polyester, and others, including polymeric materials, can cause discomfort to its wearer, especially a child or an elderly person. If the labels are sewn into the translucent fabric of clothing, they can “shine through” through this fabric, thereby worsening the appearance of the product. If the labels are sewn onto such stretchy fabric, they can stick out or bulge, which also detracts from the appearance of the garment.

For these reasons, the labels are cut off. In the absence of a special tool, the labels are cut off with scissors available in everyday life, for example, nail scissors. The use of such a tool carries the risk of damaging the tissues and/or threads that make up the suture, which carries the risk of accidental damage. Therefore, when cutting labels, they try to avoid as close as possible the cutting edges of the scissors to the seam. The possibility of an accurate cut in this case is difficult, the need to be careful does not allow you to cut the labels quickly, and the size and shape of the part The uncut label that remains after cutting may be sufficient to cause physical discomfort to the wearer and/or detract from the appearance of the product.

### DISCLOSURE OF INVENTION

The objective of the present invention is to provide a shear tool for near-weld cutting. No instrument with such purpose has been found in the prior art.

For this, scissors are proposed, containing two lever parts, each of which has a working part at one end, and a handle at the other end.

The working part of one of the parts has a cutting edge, and the working part of the other has at least one longitudinal slot for introducing cut material, forming a blade above the slot and a blade under the slot.

The peculiarity of the proposed scissors is that the working part of one of the parts has a cutting edge that is common for scissors, and the edge that adjoins with it during the cutting process is at the blade under the slot of the working part of the other part.

The fabric of the working part of the part, located around the slot, prevents the fabric and/or threads that make up the seam from getting on the cut line, eliminating the risk of damage.

In this case, the web above the slot and the web under the slot also serves as a stop when pulling the label to be cut off. The possibility of tensioning the cut label helps to ensure the tightest fit of the working part of the scissors with a slot to the seam and, accordingly, the maximum possible approach to it of the edges that are closed during the cutting process. The cut in this case turns out to be neat, and after the cut, a minimal residue of a label of the correct shape forms near the seam.

The proposed scissors make it possible to insert the label to be cut into the longitudinal slot of the working part of one of the parts, to hold it, pressing the edge of the web under the slot and the cutting edge of the other part to the seam as much as possible, carefully cut the label without damaging the seam. This is a new technical result achieved by the claimed invention.

It is preferable that the working part of one of the parts has a longitudinal slot for introducing the cut material, the width of which is as close as possible to the thickness of the cut material.

It is also preferred that the web above the slot and the web below the slot in the zone of the slot have the smallest possible thickness

If necessary, the edge that the web has under the slot can be made cutting.

### BRIEF DESCRIPTION OF THE DRAWINGS

FIG. 1 scissors, general view;

FIG. 2 fragment of scissors; the working part of one of the parts has an open longitudinal slot;

FIG. 3 the working part of the part, which has two open slots of various sizes;

FIG. 4 the working part of the part, which has an open slot of variable width;

FIG. 5 working part of the part with a closed slot;

FIG. 6 working parts of parts with a straight end, top view;

FIG. 7 working Parts of parts with a rounded end, top view;

FIG. 8 working parts of parts with a pointed end, top view;

FIG. 9 a fragment of scissors, where the canvas above the slot and the canvas under the slot have a rectangular section of the same thickness;

FIG. 10 a fragment of scissors, where the blade above the slot and the blade under the slot have a rectangular section of the same thickness; working the part having the cutting edge is located with a gap in relation to the blade above the slot

FIG. 11 a fragment of scissors, where the canvas above and below the slot has a rectangular section of different thicknesses; the working part, having a cutting edge, is located with a gap in relation to the blade above the slot;

FIG. 12 a fragment of scissors, where the canvas above the slot and the canvas under the slot has a rectangular section of the same thickness and are supplemented with stiffeners; the working part, having a cutting edge, is located with a gap in relation to the blade above the slot;

FIG. 13 a fragment of scissors, where the canvas above the slot and the canvas under the slot has a non-rectangular section; the working part, having a cutting edge, is located with a gap in relation to the blade above the slot;

FIG. 14 a fragment of scissors, where the canvas above the slot and the canvas under the slot has a rectangular section of the same thickness; the canvas under the slot has a false blade; the working part, having a cutting edge, is located with a gap in relation to the blade above the slot;

FIG. 15 a fragment of the scissors, where the canvas above the slot and the canvas under the slot has a rectangular section of different thicknesses; the slot is made at an angle to the plane of the cut; the working part, having a cutting edge, is located with a gap in relation to the blade above the slot;

FIG. 16 shows a cutting process where the web above the slot and the web below the slot has a rectangular cross section;

FIG. 17 shows a cutting process where the web above the slot and the web below the slot has a non-rectangular section;

FIG. 18 a fragment of scissors in the process of cutting, where the blade above the slot and the blade under the slot has a non-rectangular section;

FIG. 19 cutting diagram-input of the cut material;

FIG. 20 cutting scheme-approaching the label to the seam and its tension;

FIG. 21 cutting scheme-cutting the label;

FIG. 22 fragment of scissors, where the blade over the slot is processed under the cutting edge.

### IMPLEMENTATION OF THE INVENTION

The proposed scissors contain lever parts 1 and 2, each of which has a working part at one end, and at the other end, as in this example, a handle in the form of a ring 3. Parts 1 and 2 are interconnected with the ability to move relative to each other, which in this example is implemented using a hinge 4.

The working part of the part 1 has a cutting edge 5, and the working part of the part 2 has a longitudinal slot 6 forming a web 7 above the slot and a web 8 under the slot. The blade 7 has an edge 9 located with the possibility of closing along the cut line with the cutting edge 5 of the working part of the part 1.

To increase the efficiency of the cut, the edge 9 can also be made cutting. To do this, it can be processed under the cutting edge or made with an overhead blade 10 (FIG. 14).

There may be other versions of the edge 9.

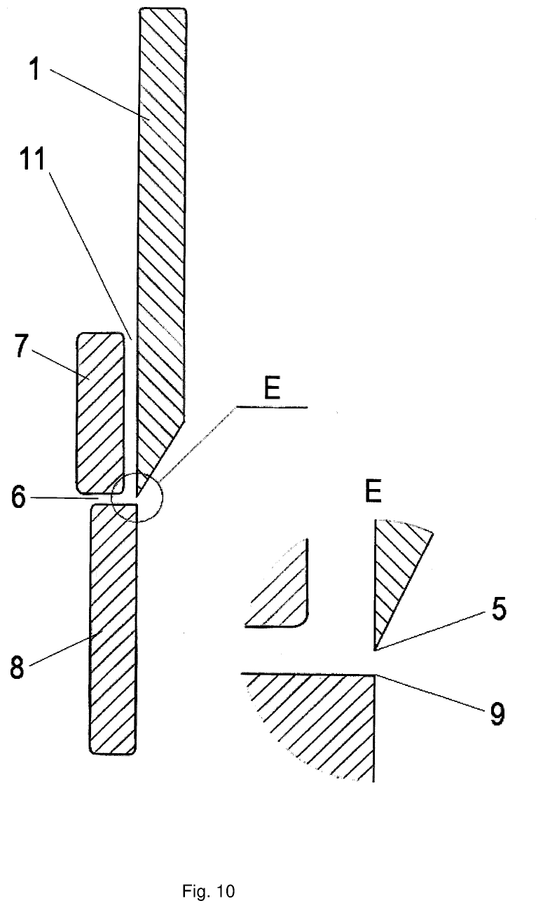

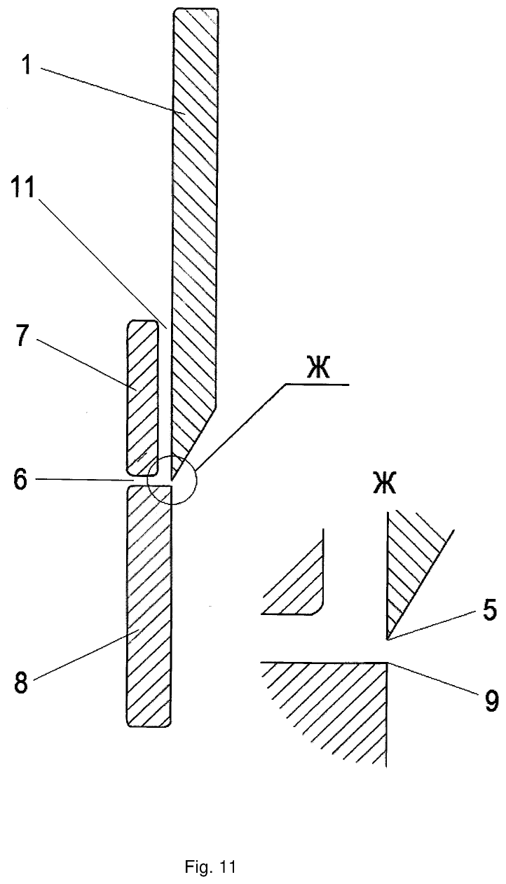

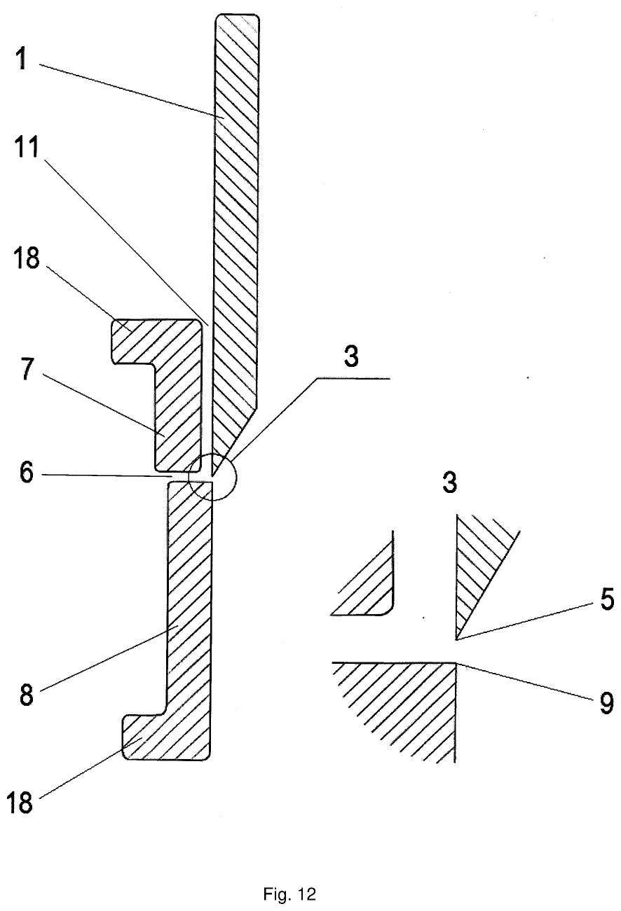

To reduce wear of the cutting edge 5, it is preferable to provide a constant gap 11 between the working part of the part 1 and the blade 7 for the length of the cutting edge 5 (FIG. 10,11,12,13,14, 15, 18).

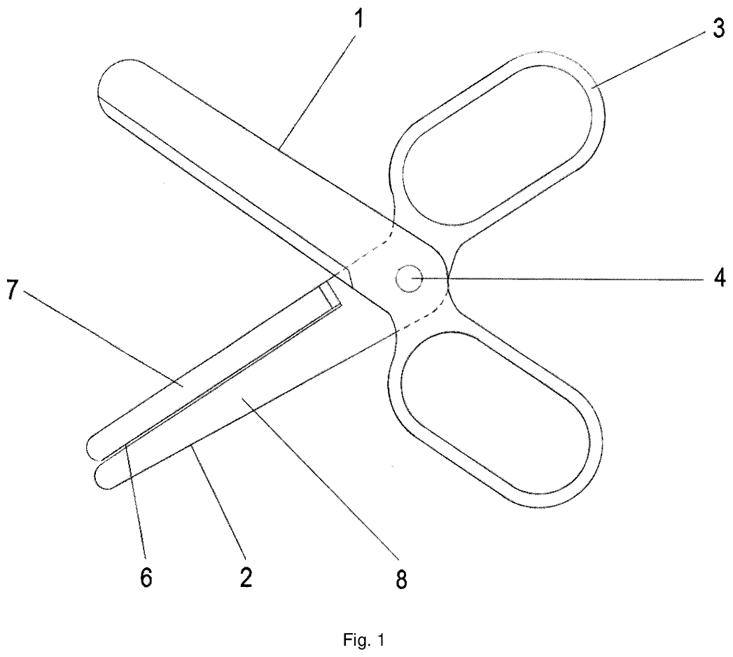

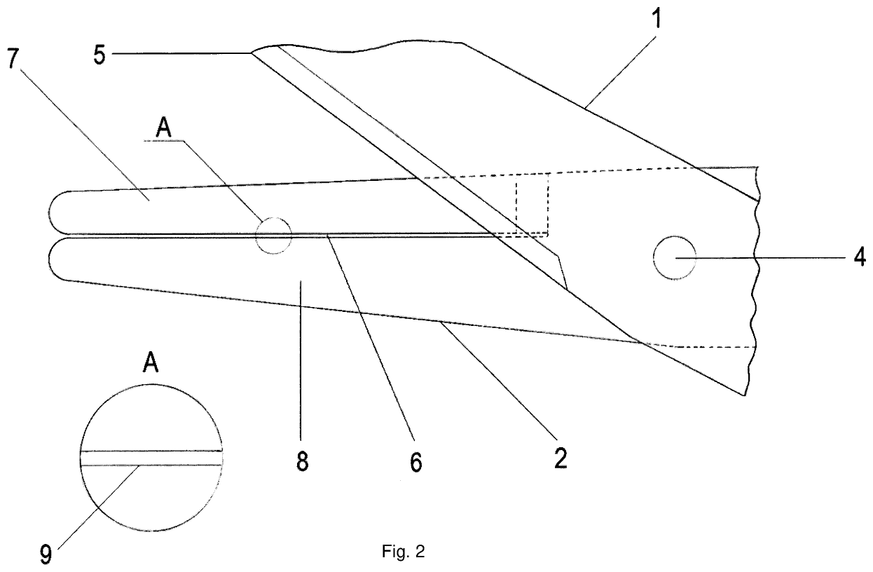

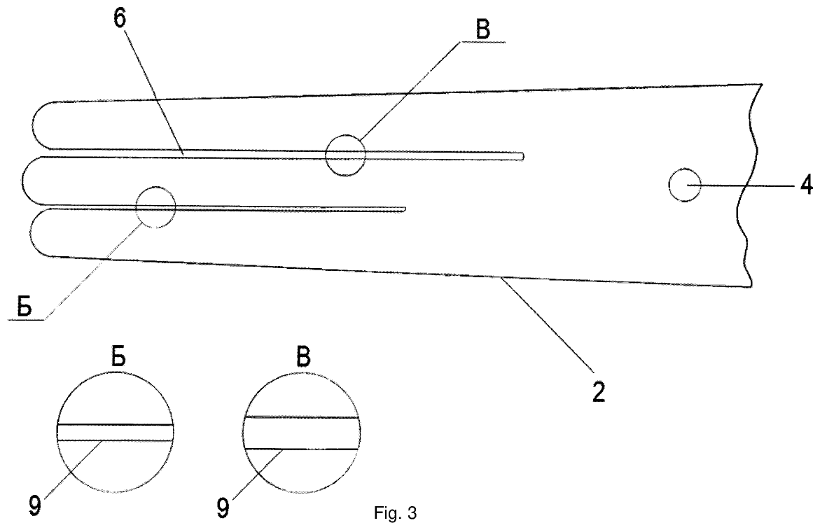

The working part of the part 2 may have one open slot (FIG. 1,2), two (FIG. 3) and more open slots.

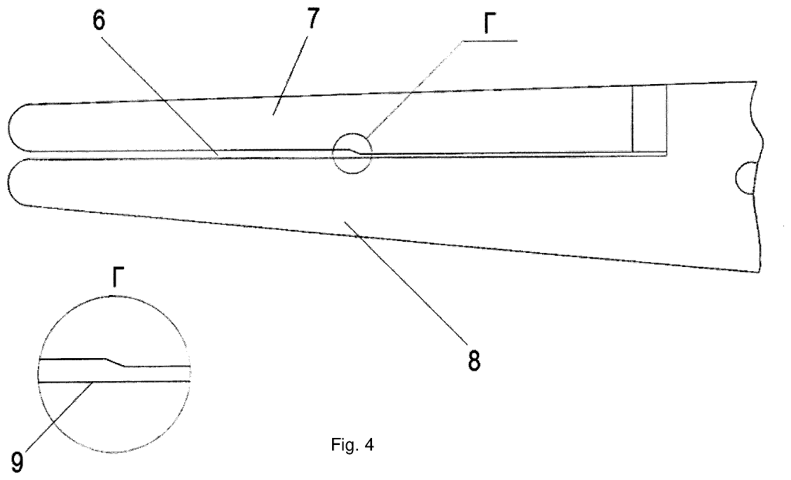

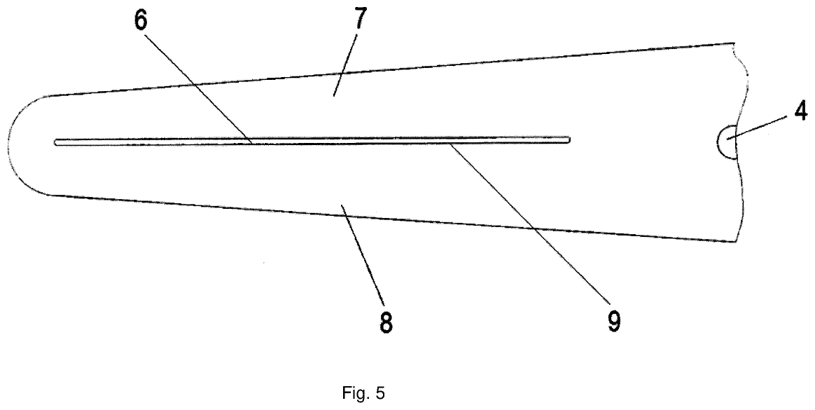

It may have a slot of variable width (FIG. 4), a closed slot (FIG. 5), as well as a combination of both.

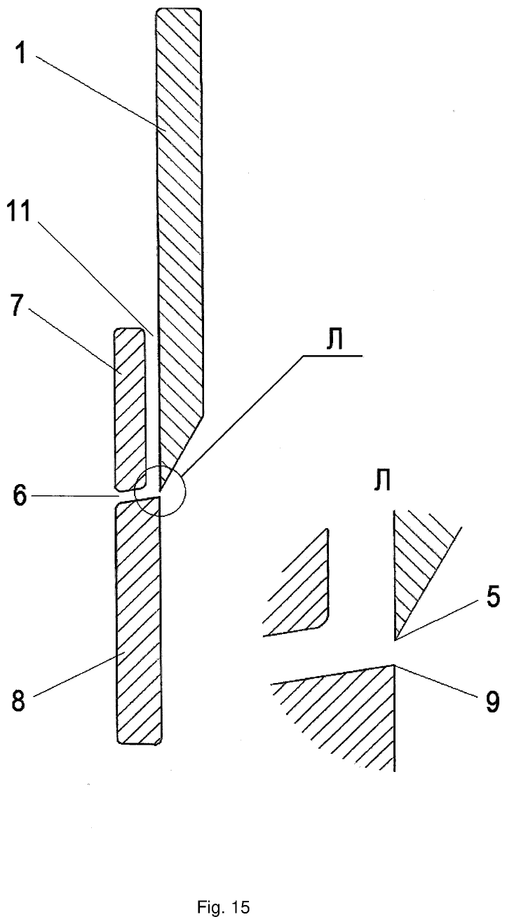

This variability will allow you to use scissors to cut labels of different thicknesses. The longitudinal slot can be made perpendicular to the plane of the cut or at an angle to it (FIG. 15).

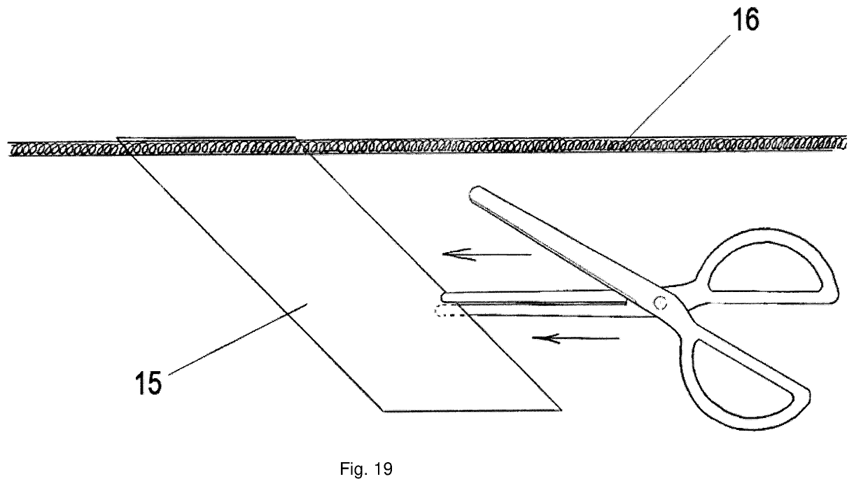

The slot can be made the most convenient entrance for inserting a cut label into it, as shown, for example, for an open slot (FIG. 19).

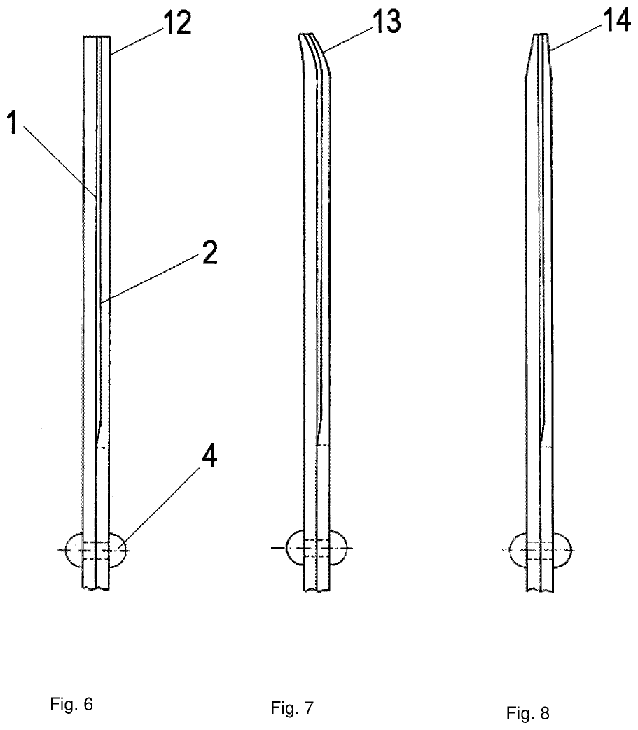

The working parts of parts 1 and 2 may have a straight end 12 (FIG. 6).

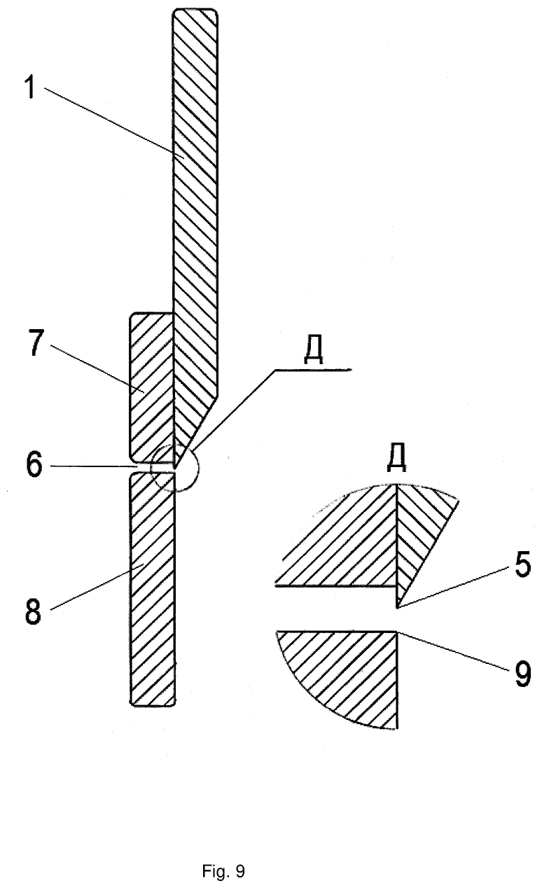

However, to “smooth” the corners of the uncut label residue and/or reduce the risk of seam damage and/or ease of use of scissors, the working parts of parts 1 and 2 may have a rounded end 13 (FIG. 7) and/or a pointed end 14 (FIG. 8).

This example shows the dimensions of the slot 5, which is present in the working part of the part 2 of the scissors for cutting a standard label 40 mm wide, 0.1-0.25 mm thick.

The length of the slot for this label can be about 45 mm.

In this case, it should be taken into account that the smaller the gap between the cut fabric will enter the slot, the less likely it will be for the fabric and/or threads from the seam 15 to get on the cut line.

Thus, the optimal slot width can be in the range of 0.15-0.3 mm.

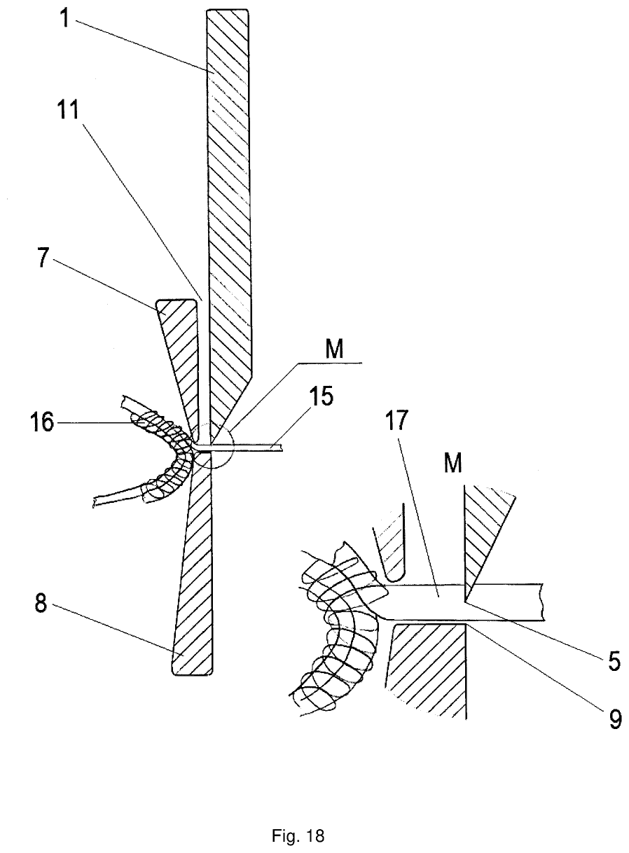

In this case, the minimum possible thickness of the web 7, as well as the web 8 in the slot zone, will ensure the maximum approximation of the edges 5 and 9 to the seam 16 (FIG. 18).

The rest of the cut label 17 in this case will be the smallest (FIG. 18).

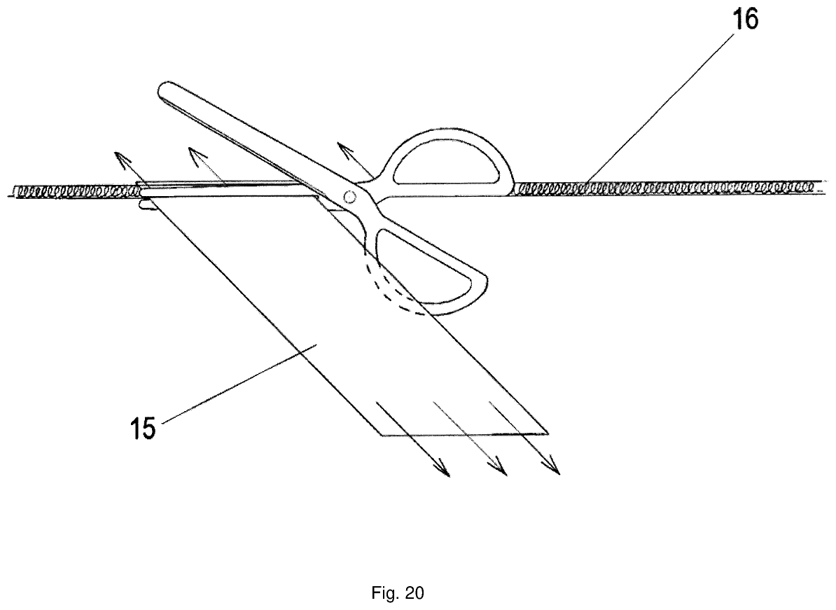

It should be borne in mind that for the maximum approximation of the edges 5 and 9 to the seam 16 (FIG. 20), the label tension is necessary, which requires the rigidity and strength of the part 2.

These requirements can be met, including the cross-sectional profile of the sheets 7 and 8.

Depending on the material and manufacturing method of the part 2, the web 7, like the web 8, may have a rectangular section of the same (FIG. 9,10,12,14,22) or different (FIG. 11.15) thickness.

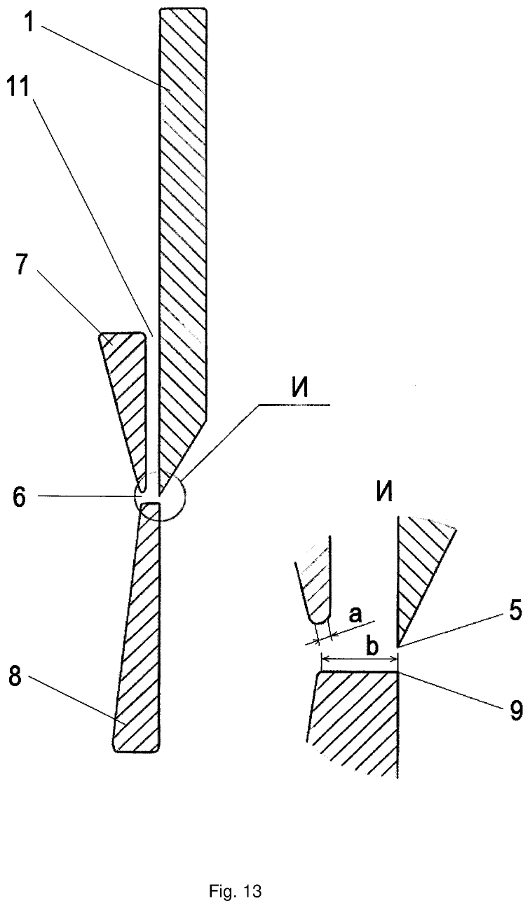

To ensure the rigidity and strength of the part 2, where the web 7, as well as the web 8, have a rectangular section of the minimum possible thickness, you can use, for example, stiffeners 18 (FIG. 12).

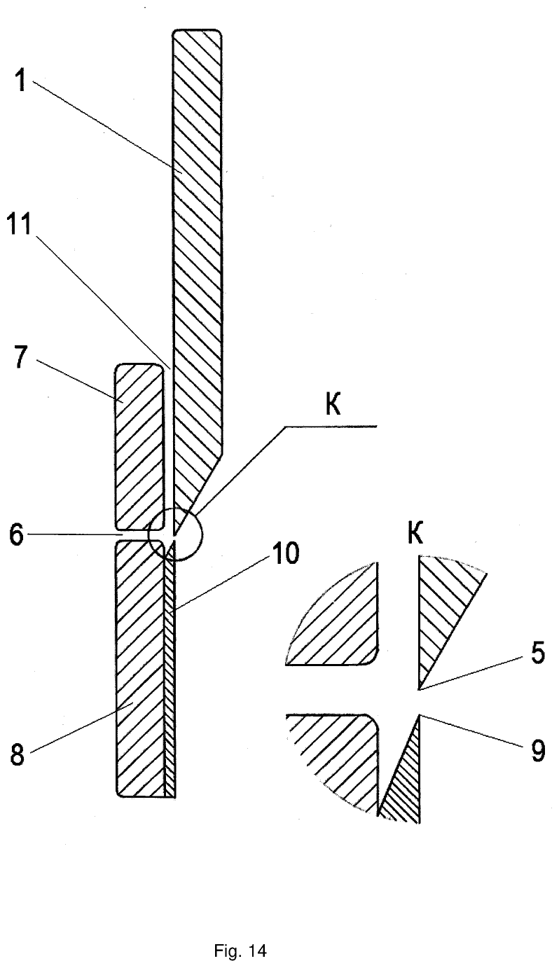

In FIG. 13 shows a fragment of scissors, where the blade 7 and the blade 8 have a non-rectangular section, while in the slot zone the blade 7 has the minimum possible thickness “a”, and the blade 8 has the minimum possible thickness “b”.

From the point of view of the rigidity and strength of part 2, a closed slot, other things being equal, may have an advantage over an open slot.

The lever parts of the scissors can be made by known methods from metals, alloys, polymeric, composite, other acceptable, including powder materials, as well as their combinations.

The scissors may contain lever parts connected to each other for movement relative to each other by means of a hinge mechanism.

Scissors can have opening limiters of lever parts of various designs, as well as opening mechanisms, for example, springs, which can be twisted, conical, disc, torsion, flat, spiral and others.

The operation of scissors is described using the example of cutting fabric labels.

The label 15 is inserted into the longitudinal slot 6 of the working part of the part 2 (FIG. 19).

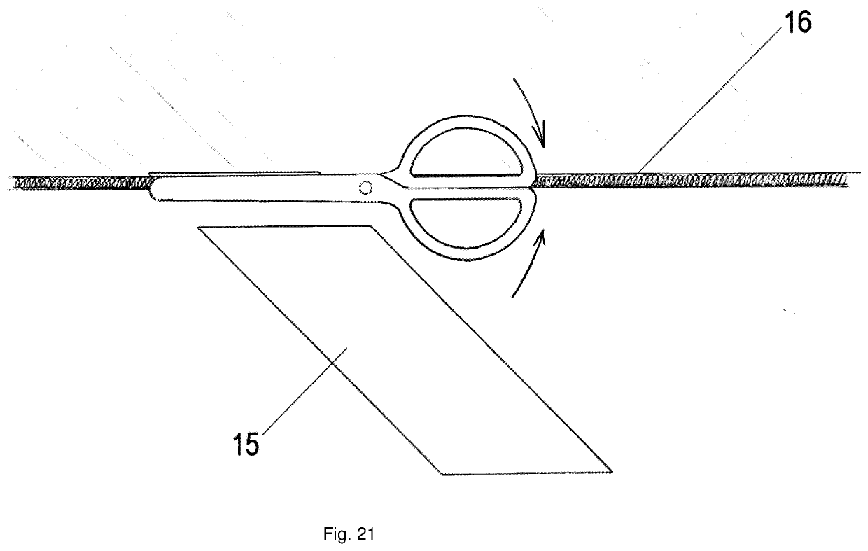

Holding and pulling the label, the working part of the part 2 and, accordingly, the edges 5 and 9 are pressed as close as possible to the seam 16 (FIG. 20), then the working parts of the parts 1 and 2 are closed and the label is cut along the cut line (FIG. 21).

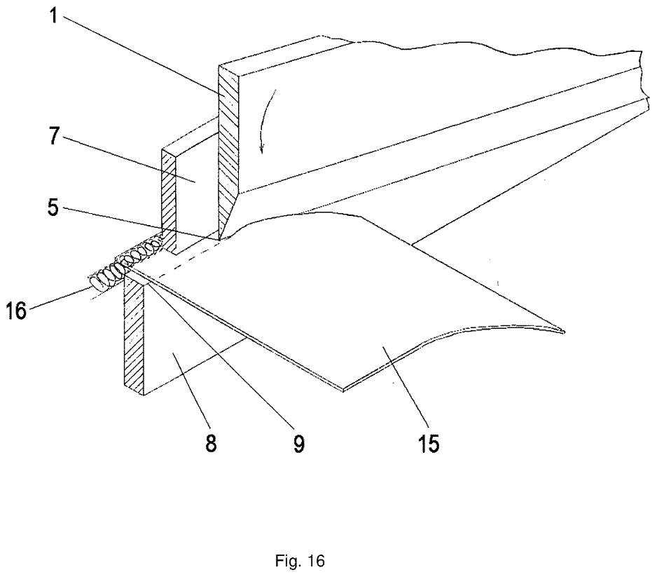

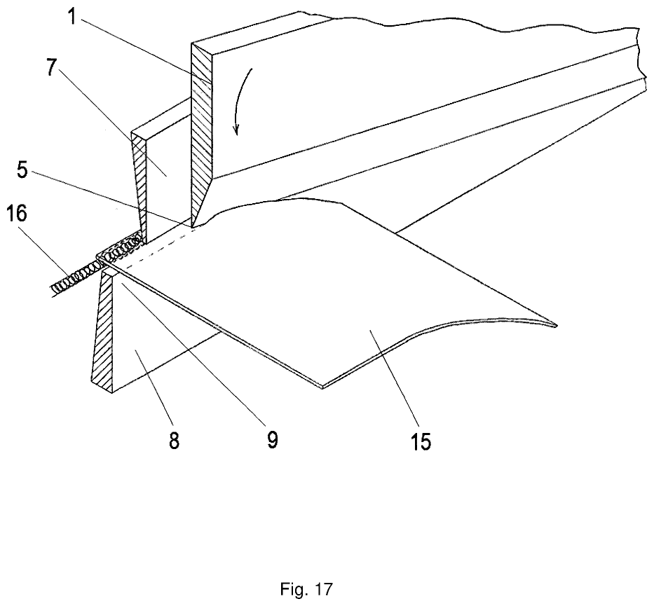

The cut line is shown with a dash in FIG. 16, 17.

The label is cut off without damaging the seam, while the uncut residue has the correct shape and minimum dimensions.

It is obvious that the principle of operation of the proposed scissors can have a wider application.

This principle can be used in scissors containing structural elements of various shapes and sizes, as well as their various ratios to each other.

The choice of shape, size and ratio of structural elements among themselves depends on the type of work performed by scissors.

The shape of the lever parts, for example, may have various kinds of bends. Scissor handles can be made in the form of round, oval or curved rings, including open ones.

Handles can be straight, curved and other shapes.

working parts lever parts may have different distances to the hinge, handles, etc. Scissors can be used for household, sewing, sewing, leather and other work, as well as for work not only with clothes, but also with other products, including products made from materials with different properties.

These include, for example, a sleeping bag, a raincoat—a tent, a backpack, a sports bag and similar products.

The proposed design of scissors can be improved.

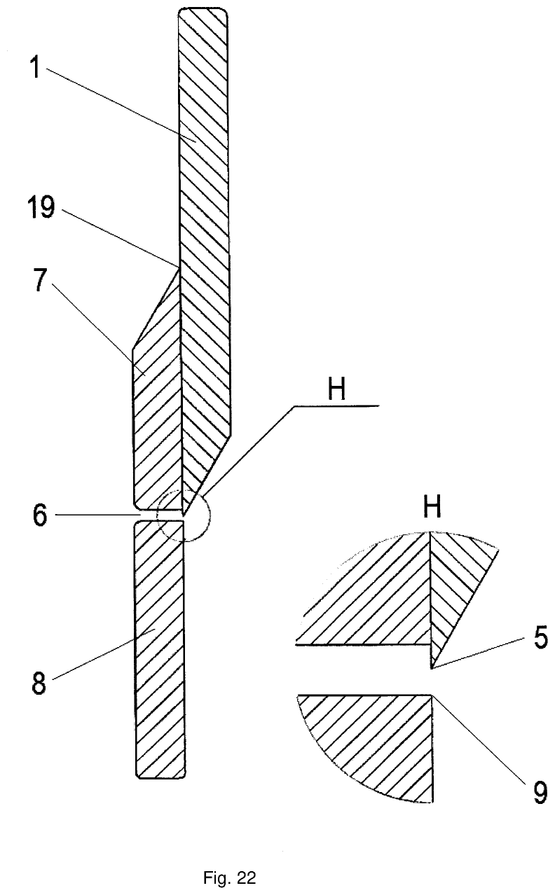

So, if the top of the canvas above the slot is sharpened under the cutting edge (FIG. 22), then the scissors can be used to cut other hidden clothing attributes.

These include, for example, a plastic tie-clamp for attaching tags, a bag with a piece of spare clothing material, spare buttons.

Scissors with a cutting edge on the fabric above the slit can be used to cut threads for joining paired clothing, such as socks, gloves, a hat-scarf pair, etc.

Thus, the proposed scissors are a new specialized tool for convenient and accurate seam cutting, the use of which will eliminate the possibility of accidental damage to the seam of the product, minimize the risk of discomfort for the wearer, and cut labels not only accurately, but also quickly, which is convenient for the user.

1-4. (canceled)

5. Shears for seam cutting comprising:
a first lever part, wherein the first lever part has a first working part at one end and a first handle at the other end, wherein the first working part has at least one longitudinal slot forming a cutting gap, wherein the cutting gap is configured for receiving cut material, wherein the slot is defined by an inner blade member extending inwardly from the slot and an outer blade member extending outwardly from the slot, wherein material of the outer blade member has a first cutting edge; and
a second lever part, wherein the second lever part has a second working part at one end and a second handle at the other end, wherein the first and second levers parts are interconnected and movable relative to each other, wherein the second working part has a second cutting edge, wherein the outer blade member of the first lever part is positioned so that it meets the second cutting edge of the second lever part and that a constant gap is provided between the second working part of the second lever part and the inner blade member over the length of the second cutting edge.

6-7. (canceled)

8. The shears of claim 5, wherein the longitudinal slot is open at one end.

9. The shears of claim 5, wherein the longitudinal slot is closed at both ends.

10. The shears of claim 5, comprising at least two longitudinal slots.

11. The shears of claim 10, wherein one of the longitudinal slots is open at one end and the other is closed at both ends.
